(19) United States
(12) Patent Application Publication
(10) Pub. No.: US 2015/0154620 A1
(43) Pub. Date: Jun. 4, 2015

(54) SYSTEM AND METHOD FOR PROVIDING FORECASTING TOOL AND MARKET VALIDATION FOR NEW PRODUCTS OR CONCEPTS

(71) Applicant: Michael T. Diep, Fountain Valley, CA (US)

(72) Inventor: Michael T. Diep, Fountain Valley, CA (US)

(21) Appl. No.: 14/561,198

(22) Filed: Dec. 4, 2014

Related U.S. Application Data
(60) Provisional application No. 61/911,554, filed on Dec. 4, 2013.

(51) Int. Cl. G06Q 30/02

(52) U.S. Cl. CPC G06Q 30/0203

(57) ABSTRACT

This invention provides a system and method for collecting data from consumers, focus groups, or other test participants including professionals and layman in a game show to provide a more accurate forecasting tool and market validation for new product launches, reintroductions, or concept testing for audience feedback and voting through the use of television, smart phone applications, and computer-hosted platforms.

### INCORPORATION BY REFERENCE

This application claims benefit of Provisional Patent Application Ser. No. 61/911,554, filed on Dec. 4, 2013, titled “Novel Market Validation Method” which application is hereby fully incorporated by this reference in its entirety and made a part hereof.

### FIELD OF THE INVENTION

The present invention is directed to a system and method for collecting data from consumers, focus groups, or other test participates to provide a more accurate forecasting tool and market validation for new product launches, reintroductions, or concept testing through audience feedback and voting using television, smart phones applications, and computer-hosted platforms.

### BACKGROUND OF THE INVENTION

Many times when an inventor has an idea for a product, he wishes to sell the idea to an established company in industry. Often, however, the established company is hesitant to develop the product due to limited market validation. The present invention features a system and method if providing a more accurate forecasting tool and market validation for the product.

The Importance Of Validation. Market validation of an idea for a product before committing to getting it built is important for a variety of reasons. When it comes to new products, by definition the inventor is making assumptions, sometimes many assumptions. The inventor needs to validate his key hypotheses and assumptions as early as possible, because of the assumptions are incorrect. If the incorrect assumptions are significant, the resulting product will not be successful and the inventor will not be in business for very long.

Market validation also helps the inventor avoid the most common problem—spending time and money building something nobody wants. When a product failed, chances are that it was based on an idea by which the inventor was enamored but the product was not something that solved a real pain point for most other people.

Market validation also forces the inventor to get in touch with the users, and this could save the inventor the trouble of building a product that is difficult for the consumers to use or understand. In fact, even when an inventor comes up with a good idea for a product, it is possible that the market is not ready for the product. Therefore, market validation can help determine whether an idea for a product is ahead of its time.

Market validation further allows the inventor to determine if he is headed down the wrong path. Moreover, it is easier and much more cost efficient to change course sooner rather than later. Furthermore, it is also less likely that the inventor will have to pivot later.

Moreover, market validation will assist the inventor in refining his ideas for the product and learn more about the product's potential users. This will allow the inventor to not only build a product that fulfills a need, but also a product that users will want.

Finally, and most importantly, market validation will help the inventor determine if people will buy the product before it is built. After all, aside from fulfilling a need, an important part of bring an idea for a product to market is to build a successful product that others will buy.

Market validation will help the inventor answer several important questions as to the product itself and to the buyers. For example, it is important for the inventor to understand the target market that he wants to address or how big the addressable market size it. This will allow the inventor to build a product that is suitable for the addressable market, and understand whether the market size is large enough for the business to be profitable.

After recognizing the target market and its size, the inventor will need to understand what is the biggest problem people face, and whether such problem is an isolated problem or a recurring problem. If it is an isolated problem, people may be less likely to spend time and money to address it, especially if it is not a big inconvenience. However, if it is a recurring problem, people may be more willing to spend time and money to address it, especially since a small inconvenience turns into a big inconvenience when it is a recurring inconvenience.

Next, the inventor will need to determine what kind of product would help relieve the pain or inconvenience that people face. The inventor will need to determine whether his idea for the product solve the issues.

Then, even if the idea for the product does solve the issue, will people pay for such a product. This is because some issues are so minor that people do not feel the need to address it. This may also be true if the cost of solving the issue greatly outweighs the benefit of solving the issue.

Next, the inventor will need to determine whether he is building the right product. That is, there can be a disconnect between the idea and the implementation of bring the product into market. Therefore, while the idea may be great, the actual product itself may be lacking because it does not actually accomplish or solve what it was intended to accomplish or solve.

Determining What Should Be Validated And How. The inventor needs to have a clear understanding the customer needs are separate and distinct from the solutions that people buy to address those needs. Therefore, validation comes in many forms: validating market demand, validating the customer problem, and validating the product or solution. Initially, the inventor must validating demand the validating the problem. Then, the inventor can develop a solution to solve the problem that he has identified. Finally, then inventor can validate the product that he has developed.

Difficulties With Market Validation. Developing, manufacturing, and marketing a new product or service, or even just bringing the product to the test-marketing stage, can represent a significant investment of time, effort, and financial resources. Thus, to reduce the risk of introducing products and services not desired by consumers and to better serve customers, it is common, prior to committing resources for launching a new product or concept, to obtain market validation for the product or service. In particular, it is crucial to explain the idea of a product or concept to a focus group, test panel, or other set of potential consumers in order to determine whether they would be interested in purchasing or using the product or service.

One approach to market validation is through the use of consumer interest surveys prior to bringing the product to market. Consumer interest survey can give inventors a better idea about whether consumers would actually buy the new products or services, how often they would purchase (repeat customer), how much they would pay, etc if the product were available for purchase in the market place. In addition, such surveys can also be used to determine what consumer group would most be interested in the products or services, and thereby aim to peak the interest of those targeted groups through the product or service's advertising and packaging types.

Consumer interest surveys can be accomplished in a variety of different methods. For instance, the surveys can be conducted through an interview, wherein the interviewers ask prescreened or randomly selected participants questions. They may also be done by other techniques such as through the telephone, direct mail surveys, in-person questionnaire, or over the Internet. Furthermore, questionnaires can be delivered in many different ways, and sampling can be used to determine consumer likes and dislikes. Consumer interest surveys are generally not as accurate as a limited test-marketing campaign, such as one that would occur in a selected market or demographic. However, they are relatively inexpensive to conduct and can yield valuable information for deciding whether to proceed to the next stage of introducing or marketing a new product or further developing a service offering. Furthermore, the surveys can be a preliminary step of a market validation campaign before moving on and committing more resources to a limited test-marketing.

While pre-launch data can be very useful, unfortunately, it can often give inaccurate expectations and predictions about the probability of success of a new product or service. Such situations can be not only embarrassing but also very costly for a manufacturer if the expected or predicted purchasing units as suggested by the survey are not attained. Inaccurate expectations of success of a new product or service can, for example, create disappointing results if the expected purchasing levels are not present after the product is launched. On the other hand, it is also possible under some circumstances for marketers to underestimate the demand for a new product or service. Inability to supply the market with the products or services can also be problematic, as it can strain relationships with retailers. Furthermore, it can also discourage consumers from seeking out the desired products or services or result in failure to capture the market or obtain the maximum profit.

Another problem with surveys is that the results can sometimes provide inaccurate consumer purchase preferences for a variety of reasons. For example, this may be due to participants or subjects providing feedback that does not match their actual behavior or purchasing habits, whether consciously or subconsciously. While few consumers in a survey may intentionally supply incorrect answers, most participants generally try to be as accurate as possible. However, their answers may not exactly correspond to their actual behavior for a number of different reasons. One such reason is that test panelists sometimes find the questions to be confusing or misleading. Another reason for inaccuracy may be that the panelist is flattered that someone is asking for their opinion, and consequently is overly polite to the interviewer and indicates interest in the product even though the consumer wouldn't have enough interest in the actual product to seek it out and actually pay money to buy it. Still other reasons may include inputting errors or compiling survey responses. All of the foregoing can lead to inaccurate data when trying to interpret whether to continue supporting and bring a product or service to market.

Currently, conducting a scientifically sound new product or marketing concept test can be an expensive endeavor. Professionally designed concept tests can cost upwards of $6-8,000 per concept tested, and a single focus group can cost around $12,000. Since this is outside the reach of many marketers and small business owners, they instead often must rely upon their own intuition or the opinions of a few friends or colleagues.

A need, therefore, exists for an accurate and more economical way to test new product or market concepts in order to provide market validation.

### OBJECT OF THE INVENTION

Accordingly, it is an object of this invention to provide a method and system for collecting data from consumers, focus groups, or other test participates to provide a more accurate forecasting tool and market validation for new product launches, reintroductions, or concept testing.

It is also an object of this invention provide a method and system for market validation that can be done through the use of computer, tablets, smart phones, television, and web cast or streaming.

It is also an object of this invention provide a method and system for market validation through a mass audience through an online platform with the use of computer voting and feedback system.

It is also an object of this invention to provide a method and system for market validation of a product to determine the target market of the product.

Accordingly, it is also an object of this invention to provide a method and system for market validation of a product to determine the biggest problem or inconvenience that people face and to determine whether the problem is isolated or recurring.

Accordingly, it is also an object of this invention to provide a method and system for market validation of a product to determine whether and what kind of product would help relieve or eliminate the problem or inconvenience that people face.

Accordingly, it is also an object of this invention to provide a method and system for market validation of a product to determine if people would be willing to pay for such a product if it existed.

Accordingly, it is also an object of this invention to provide a method and system for market validation of a product to determine if building the product would be worth it.

Accordingly, it is also an object of this invention to provide a method and system for market validation of a product to determine if the market size is substantial enough to justify bring the product to market.

Accordingly, it is also an object of this invention to provide a method and system for market validation of a product to determine if the correct product is being built based on the idea that was developed to solve the existing problem or inconvenience.

Accordingly, it is also an object of this invention to provide a method and system for market validation of a product that is less expensive, and therefore, more cost-effective to be carried out.

Accordingly, it is also an object of this invention to provide a method and system for market validation of a product that is less time consuming in order for a product to be brought to market in a timely manner.

Accordingly, it is also an object of this invention to provide a method and system for market validation of a product that is more accurate in forecasting the success of the product.

### SUMMARY OF THE INVENTION

The present invention features a method of market validation. In some embodiments, the method comprises providing an invention invented by an inventor. In some embodiments, the invention is selected from a group of inventions via a selection process. In some embodiments, the method comprises providing a panel of judges, retail judges, and manufacturing judges. In some embodiments, the judges, retail judges, and manufacturing judges evaluate the inventions selected via the selection process. In some embodiments, the method comprises providing a television show to show to a mass audience. In some embodiments, the inventions are presented by the inventors that have been selected via the selection process to the panel of judges, retail judges, and manufacturing judges in stages on the television show.

In some embodiments, the method comprises providing a smart phone application to a mass audience. In some embodiments, the television show is viewed by the mass audience. In some embodiments, the inventions are voted on by the mass audience watching the television show via the smart phone application. In some embodiments, the method comprises collecting market data from the mass audience via the smart phone application.

In aspect of the invention, a system for market validation of product is disclosed comprising at least one inventor user; at least one retail judge user; at least one manufacturing judge user; at least one audience user; a market validation platform hosted by a computer wherein the market validation platform is comprised of: an inventor selection module wherein the module allows the inventor user to submit the inventor user's product invention; a retail judge module wherein the retail judge module allows the retail judge user to rate the inventor user's product invention thereby generating a retail judge rating; a manufacturing judge module wherein the manufacturing judge module allows the manufacturing judge to rate the inventor user's product invention thereby generating a manufacturing judge rating; an audience user nodule wherein the audience user module enables the audience user to rate the invention user's product invention thereby generating a audience user rating; a final product module wherein the final product module selects a winning invention based on results of the manufacturing judge module, the retail judge module and raid audience user module.

In one embodiment, the operation of the system is broadcast to public via a television broadcast system. In one embodiment, the audience user can interact with the inventor user and further interact with the inventor selection module. In one embodiment, the audience user can interact with the retail judge user and further interact with the retail judge module. In one embodiment, the audience user can interact with the retail judge module and influence the retail judge rating. In one embodiment, the audience user can interact with the manufacturing judge and interact with the manufacturing judge module. In one embodiment, the audience user can interact with the manufacturing judge module and influence the manufacturing judge rating. In one embodiment, the audience user can interact with the final product module and influence the selection of wining selection. In one embodiment, the system further comprising at least one manufacturing user and a manufacturing bidding module wherein the manufacturing user can bid for the right to product the winning selection. In one embodiment, the system further comprising at least one retail user and a retail bidding module wherein the retail user can bid for the right to sell the winning selection. In one embodiment, the retail bidding module further comprises a subscriber feedback module wherein the subscriber feedback module allows the audience user to provide feedback. In one embodiment the retail bidding module further comprises a selection module wherein the selection module allow the retail user to review real time committed interests of the winning invention and pre-committed order of the winning invention. In one embodiment, a forum module is included wherein the forum module is comprised of an inventor page module and a product review module.

In one embodiment the inventor page module hosts an inventor page for the inventor. In one embodiment, the product review module is comprised of a judge testimonial module wherein the judge testimonial module hosts testimonials of the retail judge and the manufacturing judge. In one embodiment the market validation platform further comprising a incentive module wherein the incentive module comprises a top voter module wherein the top wherein the top voter module hosts an entry of list of the audience user and further provides for the audience user to confirm the entry. In one embodiment the market validation platform further comprising a incentive module wherein the incentive module comprises a daily update module wherein the daily update module provides for the audience user to login daily to determine if the audience user is a prize winner. In one embodiment, the market validation platform further comprising an incentive module wherein the incentive module comprises a priority voter display module wherein the priority voter display module hosts a preferred list of entry of the audience. In one embodiment, the market validation platform further comprising an incentive module wherein the incentive module comprises a top voter display module wherein the priority voter display module hosts a list of entry of the audience user. In one embodiment, the audience user module allows the audience user to purchase the winning invention.

In another aspect of the invention, a method for market validation of product is disclosed comprising at least providing one inventor user; providing at least one retail judge user; providing at least one manufacturing judge user; providing at least one audience user; having a market validation platform be hosted by a computer wherein the market validation platform is comprised of: an inventor selection module wherein the module allows the inventor user to submit the inventor user's product invention; a retail judge module wherein the retail judge module allows the retail judge user to rate the inventor user's product invention thereby generating a retail judge rating; a manufacturing judge module wherein the manufacturing judge module allows the manufacturing judge to rate the inventor user's product invention thereby generating a manufacturing judge rating; an audience user module wherein the audience user module enables the audience user to rate the invention user's product invention thereby generating a audience user rating; a final product module wherein the final product module selects a winning invention based on results of the manufacturing judge module, the retail judge module and raid audience user module.

### BRIEF DESCRIPTION OF THE DRAWINGS

These and other features and advantages of the invention will not be described with reference to the drawings of certain preferred embodiments, which are intended to illustrate and not to limit the invention, and in which:

FIG. 1 shows a schematic flow chart of the present invention describing the overall process of bring a product to market.

FIG. 2 shows a schematic diagram of the present invention describing the system hosted on a platform which is in turn hosted on a computer.

FIG. 3 shows a schematic flow chart of the incentives and benefits for inventors to participate in bring their ideas for the invention to the game show.

FIG. 4 shows a schematic diagram of the system that supports forum module hosted on a platform which is hosted on a computer.

FIG. 5 shows a schematic flow chart of the incentives and benefits for audiences or voters to follow along and participate in the game show.

FIG. 6 shows a schematic diagram of the system that supports incentive module hosted on a platform which is hosted on a computer.

FIG. 7 shows a schematic flow chart of the types of judges who will be on the game show to critic or approve the inventor's ideas.

FIG. 8 shows a schematic flow chart for the selection of the inventor and his ideas for the game show.

FIG. 9 shows a schematic flow chart of the retail buyer in determining the merits of the inventor's ideas.

FIG. 10 shows a schematic diagram of the system that supports retailer buyer module hosted on a platform which is hosted on a computer.

FIG. 11 shows a schematic flow chart for the selection of a manufacturer for the actual production of the inventor's product.

FIG. 12 shows a schematic diagram of the system that supports manufacturing selection module hosted on a platform which is hosted on a computer.

### DETAILED DESCRIPTION OF THE INVENTION

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

INVENTION/INVENTOR SELECTION. In some embodiments, the present invention features a method of market validation. In some embodiments, the present invention features a process to determine market validation.

In some embodiments, the method comprises providing an invention invented by an inventor. In some embodiments, the invention is selected from a group of inventions via a selection process. In some embodiments, inventions are solicited for inclusion in the selection process. In some embodiments, an online platform may be used to solicit inventions from the inventor for inclusion in the selection process. In some embodiments, an online platform may be used by the inventor to submit inventions for inclusion in the selection process.

In some embodiments, thirty inventions may be selected from those submitted for inclusion via the selection process. In some embodiments, thirty five or more inventions may be selected from those submitted for inclusion via the selection process. In some embodiments, twenty five or fewer inventions may be selected from those submitted for inclusion via the selection process. In some embodiments, inventions may be selected based on perceived commercial value, purpose, or interest. In some embodiments, an invention selection panel may select the inventions. In some embodiments, the inventor and the invention are both selected for inclusion into the method.

In some embodiments, the method comprises providing a panel of judges, retail judges, and manufacturing judges. In some embodiments, the judges, retail judges, and manufacturing judges evaluate the inventions selected via the selection process.

JUDGES. In some embodiments, the invention is shown to a panel of judges by the inventor. In some embodiments, there are three judges. In some embodiments, there are four judges. In some embodiments, there are five or more judges. In some embodiments, two or fewer judges. In some embodiments, each inventions is shown by the inventor to all of the judges, one at a time for a certain period of time. In some embodiments, the inventor has one minute to show the judges the invention. In some embodiments, the inventor has two minutes to show the judges the invention. In some embodiments, the inventor has three minutes to show the judges the invention. In some embodiments, the inventor has four minutes to show the judges the invention. In some embodiments, the inventor has five to ten minutes to show the judges the invention. In some embodiments, the inventor has more than ten minutes to show the judges the invention.

In some embodiments, the judges approve or disapprove of the invention immediately after the invention has been presented. In some embodiments, the judges approve or disapprove of the invention after more than one invention has been presented, for example, a group of two or more inventions. In some embodiments, the judges must await input from a mass audience before approving or disapproving the invention. In some embodiments, if the invention is approved, it will be presented to a panel of retail judges. In some embodiments, if the invention is disapproved, it will no longer be under consideration for advancement through the method and process. In some embodiments, the judges may be industry experts. In some embodiments, the judges may be entertainers. In some embodiments, the judges may be inventors.

RETAIL JUDGES. In some embodiments, the invention is shown to a panel of retail judges. In some embodiments, there are three retail judges. In some embodiments, there are four retail judges. In some embodiments, there are five or more retail judges. In some embodiments, two or fewer retail judges. In some embodiments, each inventions is shown by the inventor to all of the retail judges, one at a time for a certain period of time. In some embodiments, the inventor has one minute to show the retail judges the invention. In some embodiments, the inventor has two minutes to show the retail judges the invention. In some embodiments, the inventor has three minutes to show the retail judges the invention. In some embodiments, the inventor has four minutes to show the retail judges the invention. In some embodiments, the inventor has five to ten minutes to show the retail judges the invention. In some embodiments, the inventor has more than ten minutes to show the retail judges the invention.

In some embodiments, each retail judge is an industry expert with an expertise in retailing or retail merchandising. In some embodiments, each retail judge represents a mass retailer in an official capacity. In some embodiments, each retail judge is authorized to place bids or orders for the invention for the purpose of winning a bid to gain temporary or permanent exclusive rights for retailing the invention via the mass retailer. In some embodiments, there is an open bidding process. In some embodiments, there is a sealed bidding process. In some embodiments, there is both an open bidding process and a sealed bidding process. In some embodiments, experts may be consulted to aid the bidding process.

In some embodiments, the retail judge may win for the retailer an exclusive right to market for three months. In some embodiments, the retail judge may win for the retailer an exclusive right to market for six months. In some embodiments, the retail judge may win for the retailer an exclusive right to market for twelve months. In some embodiments, none of the bids will be revealed either to the other retail judges or to the mass audience. In some embodiments, the winning bid will be a contract and will be considered a purchase order for the product. In some embodiments, the largest quantity will win the bid.

MANUFACTURING JUDGES. In some embodiments, the invention is shown to a panel of manufacturing judges. In some embodiments, there are three manufacturing judges. In some embodiments, there are four manufacturing judges. In some embodiments, there are five or more manufacturing judges. In some embodiments, two or fewer manufacturing judges. In some embodiments, each inventions is shown by the inventor to all of the manufacturing judges, one at a time for a certain period of time. In some embodiments, the inventor has one minute to show the manufacturing judges the invention. In some embodiments, the inventor has two minutes to show the manufacturing judges the invention. In some embodiments, the inventor has three minutes to show the manufacturing judges the invention. In some embodiments, the inventor has four minutes to show the manufacturing judges the invention. In some embodiments, the inventor has five to ten minutes to show the manufacturing judges the invention. In some embodiments, the inventor has more than ten minutes to show the manufacturing judges the invention.

In some embodiments, each manufacturing judge is an industry expert with an expertise in manufacturing or manufacturing merchandising. In some embodiments, each manufacturing judge represents a manufacturer in an official capacity. In some embodiments, each manufacturing judge is authorized to place bids for manufacturing the invention for the purpose of winning a bid to gain temporary or permanent exclusive rights for manufacturing the invention via the manufacturer. In some embodiments, there is an open bidding process. In some embodiments, there is a sealed bidding process. In some embodiments, there is both an open bidding process and a sealed bidding process. In some embodiments, experts may be consulted to aid the bidding process.

In some embodiments, the manufacturing judge may win for the manufacturer an exclusive right to manufacture for three months. In some embodiments, the manufacturing judge may win for the manufacturer an exclusive right to manufacture for six months. In some embodiments, the manufacturing judge may win for the manufacturer an exclusive right to manufacture for twelve months. In some embodiments, none of the bids will be revealed either to the other manufacturing judges or to the mass audience. In some embodiments, the winning bid will be a contract and will be considered a bid to gain an order for the product. In some embodiments, the lowest price per quantity will win the bid.

TELEVISION SHOW. In some embodiments, the method comprises providing a television show to be viewed by a mass audience. In some embodiments, the inventors present the inventions selected via the selection process to the panel of judges, retail judges, and manufacturing judges in stages on the television show. In some embodiments, the television show will be a series of shows where inventions are eliminated culminating in the last few weeks of the run or season where a winning invention is named.

In some embodiments, information may be shown to the mass audience on a television screen that pertains to the invention, the selection process, the panel of judges, the panel of retail judges, or the panel of manufacturing judges. In some embodiments, information pertaining to the bidding process may be shown to the mass audience on a television screen as part of the television show.

SMART PHONE APPLICATION. In some embodiments, the method comprises providing a smart phone application for installation on a mobile phone to a mass audience. In some embodiments, the television show is viewed by the mass audience. In some embodiments, the inventions are voted on by the mass audience watching the television show via the smart phone application.

In some embodiments, the smart phone application provides a voting platform for the invention. In some embodiments, the smart phone application is in synchronization with the television show for voting purposes. In some embodiments, the smart phone application displays a question as follows: “Will you buy this product?” In some embodiments, the user of the smart phone application will answer the question and enter a response. In some embodiments, the response is transmitted to a tabulation center. In some embodiments, responses are tabulated to determine the number of viewers in the mass audience who would respond positively to the question. In some embodiments, a predetermined response threshold is established. In some embodiments, the responses are used to determine either fully or partially if the judges approve or disapprove of the invention.

In some embodiments, the method includes benefits to the mass audience for downloading the smart phone application. In some embodiments, the benefit may be one or more opportunities to receive a free product. In some embodiments, the product may be one or more of the inventions presented. In some embodiments, the benefit may be one or more opportunities to receive a discounted product, for example, twenty percent off, thirty percent off, forty percent off, fifty percent off, sixty percent off, seventy percent off, eighty percent off, or ninety percent off.

In some embodiments, the benefit may be recognition as a contributor. In some embodiments, the recognition may be receiving a limited edition product. In some embodiments, the benefit may be receiving one of the first products produced in the manufacturing run. In some embodiments, the benefit may be receiving an autographed or sequentially numbered product.

In some embodiments, the smart phone application is designed to work on iPhones™ In some embodiments, the smart phone application is designed to work on Android™ phones. In some embodiments, the smart phone application is designed to work on Windows™ phones or other operating systems that may be used on mobile phones, tablets, computers, or similar devices.

In some embodiments, the smart phone application is promoted on the television show. In some embodiments, instructions on how to download the smart phone application is shown on the television show. In some embodiments, instructions on how to use the application is shown on the television show.

In some embodiments, the mobile phone application collects demographic data and transmits it to the tabulation center. In some embodiments, demographic data includes one or more of the following: email address, sex, age, religion, city, state, country. In some embodiments, the above data is required before downloading the mobile phone application. In some embodiments, the method comprises collecting market data from the mass audience via the smart phone application.

In some embodiments, the winning invention will be recognized on the television show. In some embodiments, the top ten inventions will be recognized on the television show.

In some embodiments, the first ten responders on the smart phone application will be recognized on the television show. In some embodiments, the first five hundred responders will be recognized on the television show. In some embodiments, the first five hundred responders win a free product. In some embodiments, a next subset, up to five hundred thousand will receive an eighty percent discount. In some embodiments, the next subset up to a million receive a fifty percent discount.

In some embodiments, the first five hundred responders will have an identifying code or name posted on a online platform. In some embodiments, a portion of the five hundred will be posted daily, for example, ten, twenty, fifty or one hundred. In some embodiments, the portion will be posted at random times throughout the day.

In some embodiments, revenue streams are provided by the smart phone application, the online platform, the television show, product placement, and future intellectual property value.

In some embodiments, value is provided to the inventor by market validation. In some embodiments, the invention will have its own website. In some embodiments, the invention will generate testimonials. In some embodiments, the invention will be reviewed. In some embodiments, the invention will be licensed. In some embodiments, the invention will be licensed at 10 percent net revenue. In some embodiments, the invention will be licensed at 7 percent net revenue. In some embodiments, the invention will be licensed at 1-3 percent net revenue. In some embodiments, the invention will be licensed at 4-6 percent net revenue. In some embodiments, the invention will be licensed at 8-9 percent net revenue. In some embodiments, royalties will be received by the inventor at the end of the television season. In some embodiments, royalties will be received by the inventor for twenty years.

In some embodiments, texting may be used instead of a smart phone application.

In some embodiments, the television show will be a contest between the inventions.

As used herein, the term “about” refers to plus or minus 10% of the referenced number.

PLATFORM HOSTED BY A COMPUTER. In some embodiments, the system provides a platform which is hosted by a computer. In some embodiments, the computer is connected to inventors, retail judges, manufacturing judges, and audiences. In some embodiments, the inventors submit inventions to the platform for the retail judges to review. In some embodiments, the inventors submit inventions to the manufacturing judges to review. In some embodiments, the audiences can provide feedback through the platform to the retail judges. In some embodiments, the audiences can provide feedback through the platform to the retail judges. In some embodiments, the audiences can win the product through the platform for free. In some embodiments, the audiences can purchase the product through the platform for a discount.

In some embodiments, the system provides a platform which is hosted by a computer. In some embodiments, the computer further hosts an inventor page module and a product review module. In some embodiments, the product review module supports a judge testimonial module and an audience “most like’ module. In some embodiments, the judges testimonial module interacts with retail judges and manufacturing judges to store judge testimonials through the platform. In some embodiments, the audience “most like’ module stores audience validations through the platform.

In some embodiments, the system provides a platform which is hosted by a computer. In some embodiments, the computer further hosts a top voters module, a daily update module, a top voter display module, and a voter display module. In some embodiments, the top voter module is further connected to a subscriber confirmation module.

In some embodiments, the system provides a platform which is hosted by a computer. In some embodiments, the computer further supports a retailer buyer module which allows the buyer to interact through the platform. In some embodiments, the computer further supports a subscriber feedback module. In some embodiments, the computer further supports a product selection module. In some embodiments, the computer further supports a retailer bid module. In some embodiments, the subscriber feedback module allows the subscriber to provide feedback through the platform.

In some embodiments, the system provides a platform which is hosted by a computer. In some embodiments, the computer further supports a manufacturing selection module. In some embodiments, the computer further supports a manufacturing user silent bid module which allows the user to interact through the platform.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. Reference numbers recited in the claims are exemplary and for ease of review by the patent office only, and are not limiting in any way. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting of”, and as such the written description requirement for claiming one or more embodiments of the present invention using the phrase “consisting of” is met.

The reference numbers recited in the below claims are solely for ease of examination of this patent application, and are exemplary, and are not intended in any way to limit the scope of the claims to the particular features having the corresponding reference numbers in the drawings.

### DETAILED DESCRIPTION OF THE DRAWING

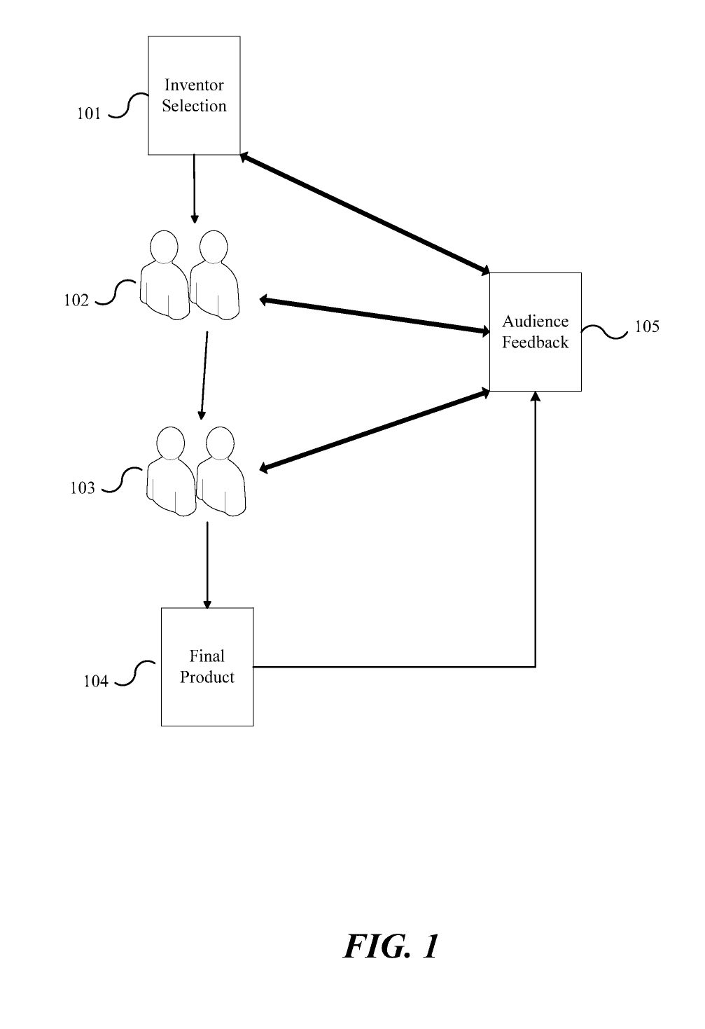

Referring to FIG. 1, the schematic flow chart shows the overall process of bring a product to market. Specifically, an inventor is selected 101. Next, the idea for the product is passed on to a panel of retail judges 102 in which they can critique or approve the product, and retailers can bid for the right to sell the product once it is introduced to the market. Finally, the idea for the product is passed on to a panel of manufacturing judges 103 in which they can critique or approve the product, and manufacturers can bid for the right to manufacture the final product 104. The audience 105 may have feedback and voting power over any or all of the steps, from inventor selection 101, retail judges 102, manufacturing judges 103, to the final product 104. The audience 105 will have the opportunity to win or purchase the final product 104 at a discount.

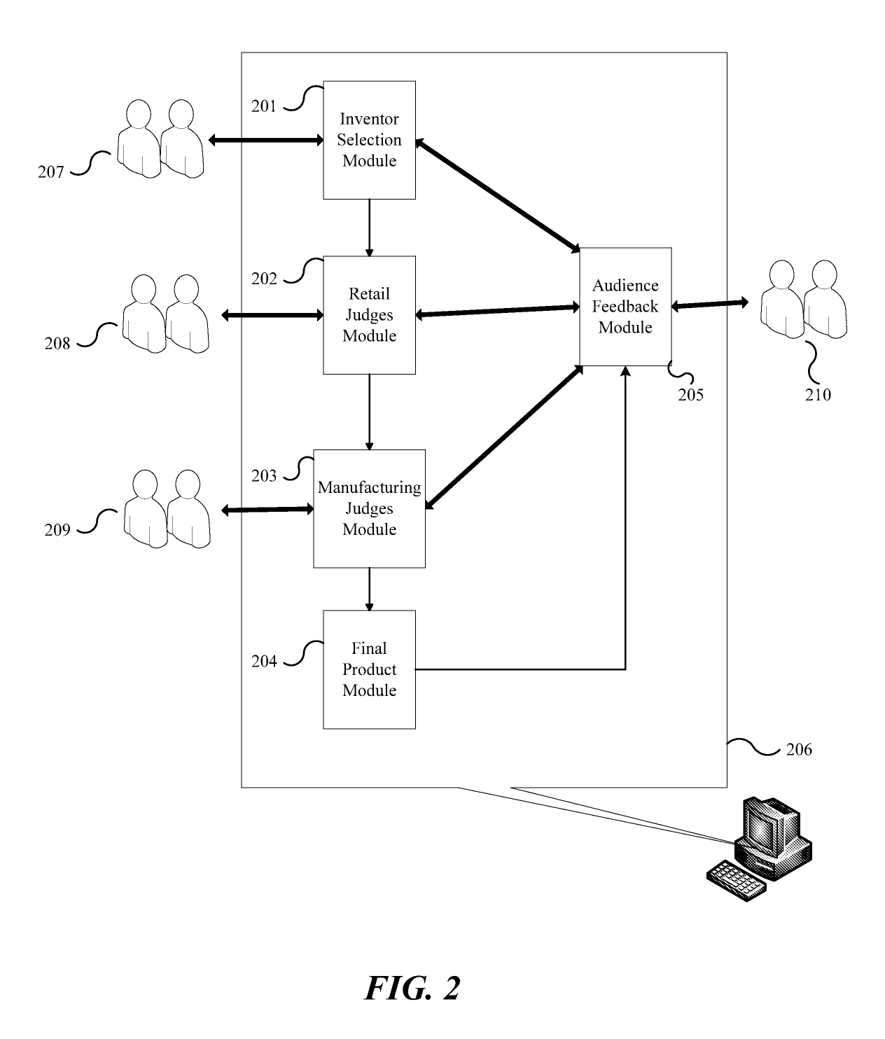

In one embodiment, the system of FIG. 2. Is hosted by a platform 206 which is hosted by a computer that is connected to inventors 207, retail judges 208, manufacturing judges 209 and audiences 210 by internet or by other means such as wireless communication or any other means. Specifically, Inventor 207 submits invention to inventor module 201 wherein the selection is presented to the retail judges 208 via the retail judges module 202, allowing the retail judges 208 to critique or approve the product. Then the winning selections are presented to the manufacturing judges 209 via the manufacturing judges module 203 wherein the manufacturers can bid for the right to manufacture the final product. The audience 210 then can view and purchase the product via the audience feedback module 205. In another embodiment, the system is inventor selection module 201, the retail judge module 202, the manufacturing module 203, and the final product module 204 broadcast their selection process to the audience 210 via TV or webcast.

In one other embodiment, Specifically, Inventor 207 submits invention to inventor module 201 wherein the selection is presented to the retail judges 208 via the retail judges module 202, allowing the retail judges 208 to rate the product. Then the product are presented to the manufacturing judges 209 via the manufacturing judges module 203 wherein the manufacturers judge can rate the product further. Then the product is also rated by the audience 210 via audience feedback module 205. And then the final product module selects the winning invention where then audience 210 can purchase the winning product. In one embodiment, the audience can interact with the inventor 207 and influence how he selects his invention via the interaction of audience feedback module 205 with inventor selection module of 201. Also Audience 210 can influence the ratings of retail judge module 202 by giving it feedback. In one example, if certain level of votes are added by the audience to a certain product, the ratings of the retail judge module may go up for a certain product. Likewise audience 210 can influence the rating of manufacturing judge module based on the interaction. Finally the final product selection may be influence by the popular vote of the audience.

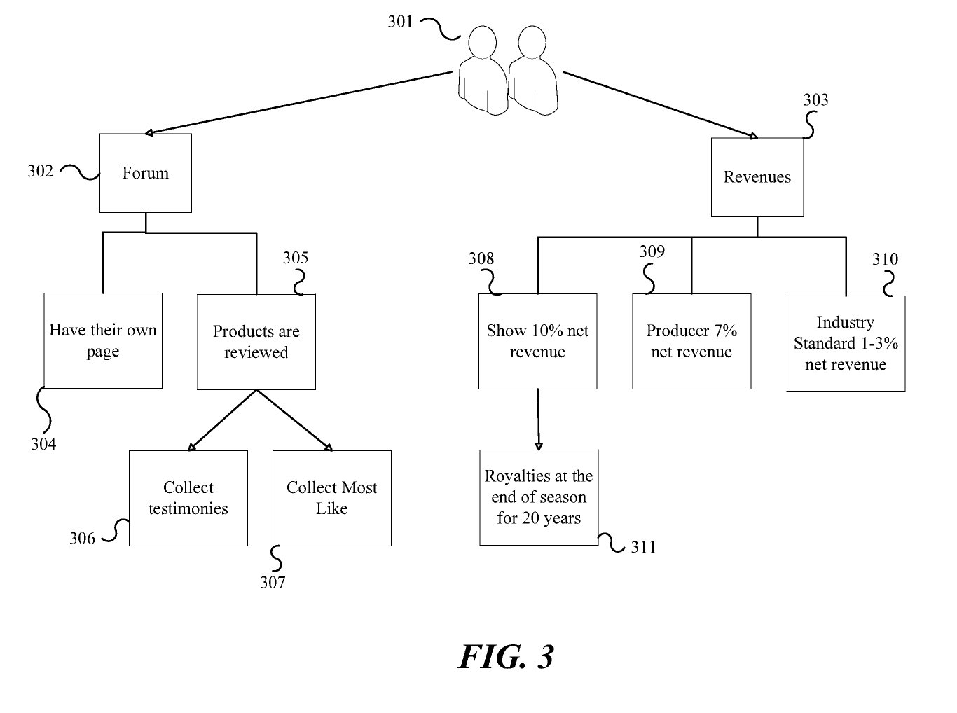

Referring to FIG. 3, the schematic flow chart show the incentives and benefits for inventors to participate in bring their ideas for the invention to the game show. Specifically, inventors 301 participate in the game show because it provides the inventors 301 a forum 302 to present their ideas and a revenue stream 303 for their ideas. The game show provides the inventors 301 a forum 302 by giving the inventors their own page 304 as well as providing a platform for their products to be reviewed 305 by the judges and the audiences. When the inventor's products are reviewed 305, they can collect testimonials 306 from the judges and collect “likes” from the audiences 307 as ways to validate their products.

Still referring to FIG. 3, the game show also provides the inventors 301 a revenue stream 303. Generally, the game show will receive a part of the revenue 308, such as 10% net revenue generated by the invention for 20 years 311. The game show producer will also receive a share of the revenue, such as 7% of the net revenue. Finally, inventor will also receive a percentage of the revenue, such as the industry standard of 1-3% of the net revenue. In one embodiment, the system supports a revenue module wherein the platform generates revenue sharing calculation base on product sales, advertisement sales, and sponsorship money.

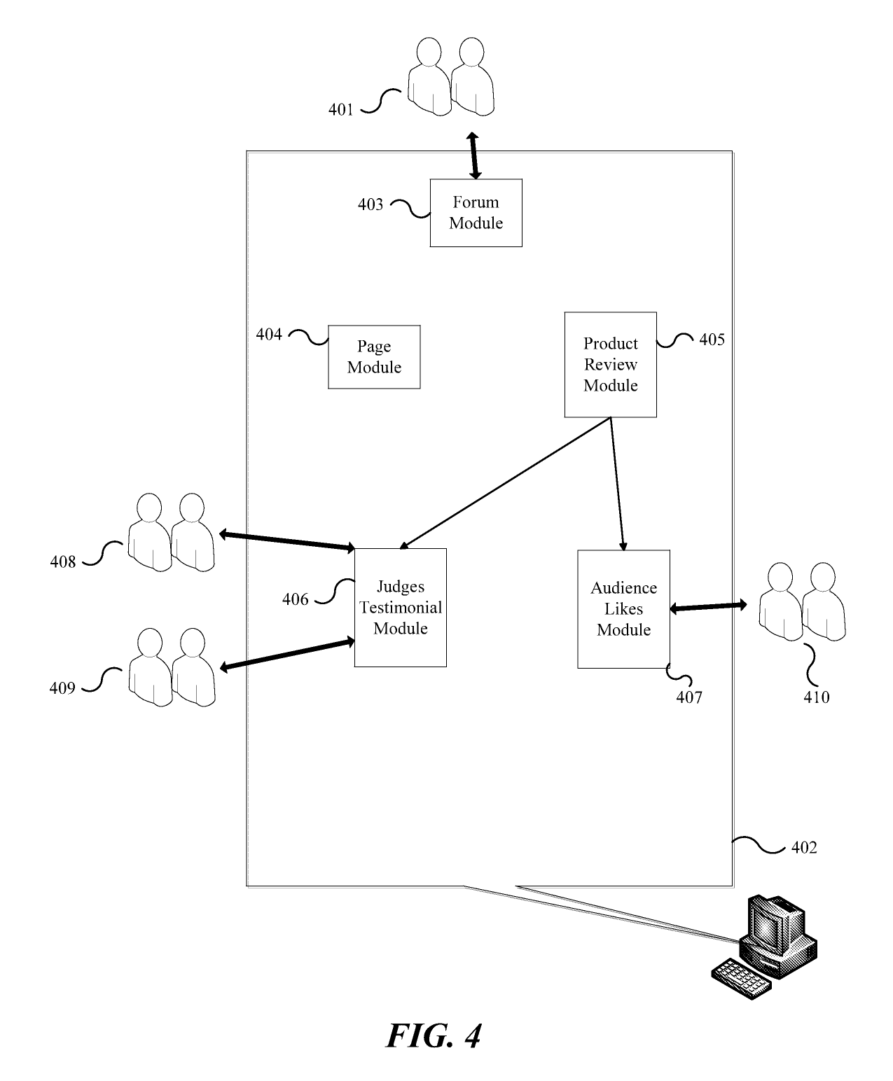

In one embodiment, the system of FIG. 4 supports forum module of 403 is hosted on a platform 402 which is hosted on a computer which further supports a inventor page module 404 to host their own page and a product review module 405 that supports a judges testimonial module 406 and an audience “most like” module 407. The judges testimonial module 406 interacts with the retail judges 408 and manufacturing judges 409 to stores judge testimonials, and the audience likes module 407 stores audience validation. The forum module can be part of the system or be hosted on a separate social network system.

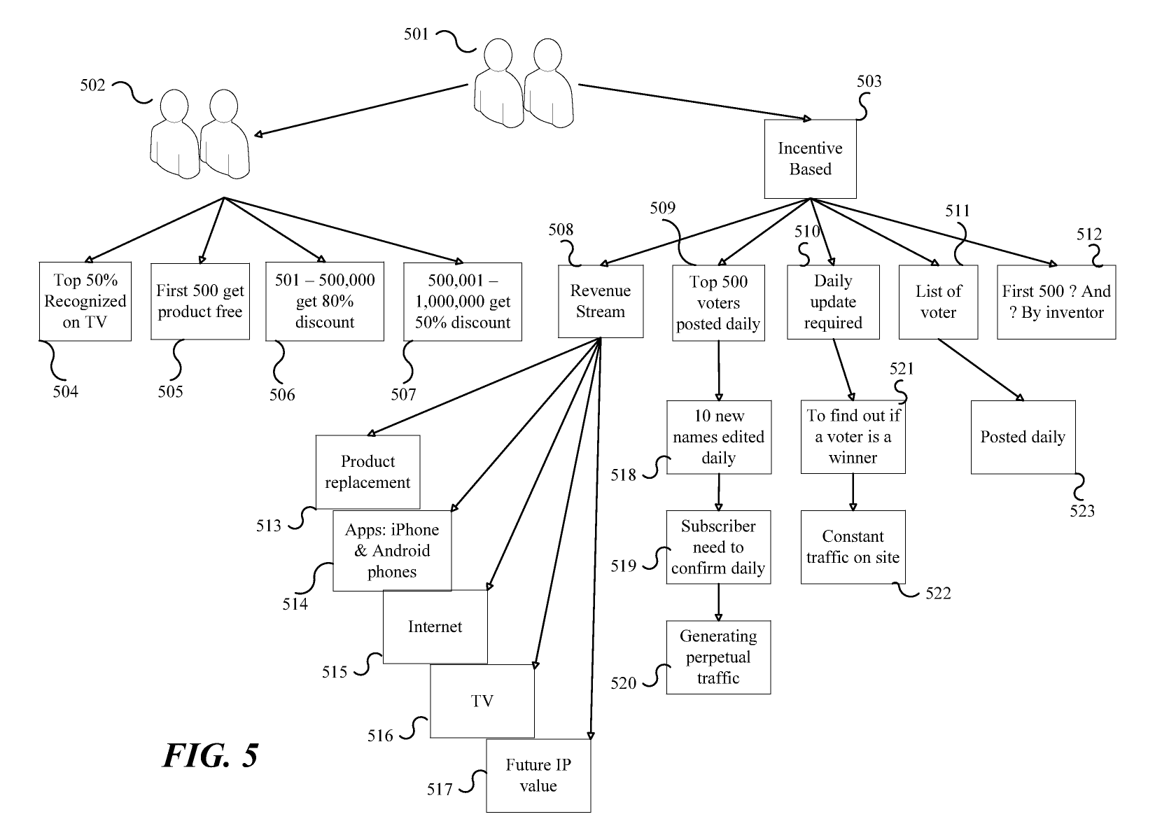

Referring to FIG. 5, the schematic flow chart shows the incentives and benefits for audiences or voters to follow along and participate in the game show. Specifically, the voters 501 will participate because they can become winners 502 to obtain products for free or purchase the product at a deep discount through incentive based interaction 503. When voters become winners 502, they can be recognized on television as the top 50-100 participant 504. They can also be chosen as the top 500 participants 505 to receive the product for free. They can also be chosen as the first 501-500,000 participates 506 to purchase the product at a deep discount for 80% off the normal price. Finally, the 500,001-1,000,000 participants can be chosen to purchase the product at 50% discount off the normal price. In one embodiment, the system hosts the winner module on the platform. The winner module further is comprised of top 50-100 participant module, the top 500 participant module, the top 501-500,000 participant module, and the top 1000000 participant module.

Still referring to FIG. 5, in order to be chosen as winners 502, the voters 501 must actively interact with certain segments of the game show, and the interaction is incentive based 503. The voters' interaction can provide revenue stream 508. The top 500 voters would be posted daily 509. Daily updates 510 from the voters 501 is required. The list 511 of top voters are recognized. The first 500 voters 301 will receive products that is uniquely numbered and signed 512 by the inventors.

Again, referring to FIG. 5, the revenue stream 508 can be provided through product placement 513, Applications or apps on the iPhone or Android Phone 514, Internet 515, Television 516, and future intellectual property (IP) value 517. In one embodiment, the system supports a voter incentive module wherein the module further comprises a revenue stream module, wherein the revenue stream module generates revenue by placing the product in the stream of commerce.

As for the top 500 voters posted daily 509, 10 new names are edited daily 518 and subscribers need to confirm their entry daily 519, because this generates perpetual traffic 320. In one embodiment, the voter incentive module wherein the module further comprises a daily updated module, wherein the top 500 voters posted daily on the internet, new names are edited daily 518 and subscribers need to confirm their entry daily 519, because this generates perpetual traffic 520.

As for the daily update requirement 510, the voters 501 must update to find out if he is a winner 521. This will further provide constant traffic flow on site 522. In one embodiment, the system further comprises daily update module where the vote can update to find out if he is a winner. Finally, as for the list of top voters 511, the list is posted daily 523 for all to see. This will provide reinforcement for the voters 501 to continue to participate and interact with relevant segments of the game show. In one embodiment, the system further comprises a top voter module where the list is posted daily for all viewers to see

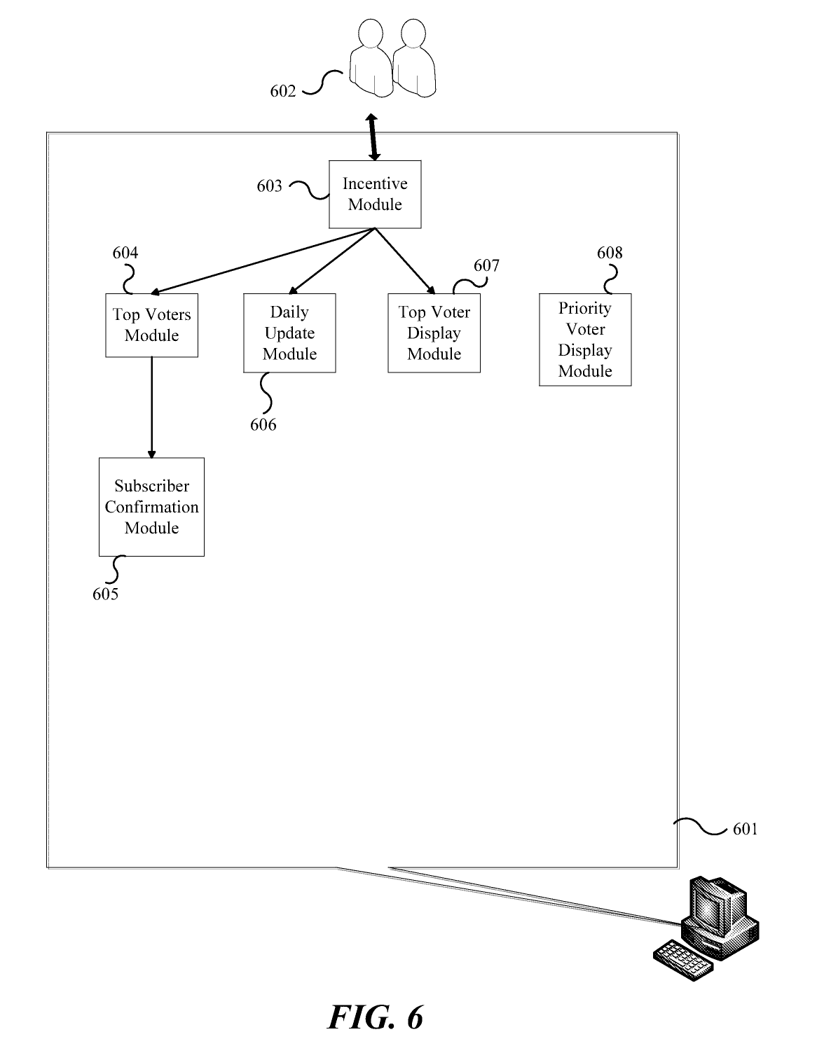

The system of FIG. 6 that supports incentive module of 603 that is hosted on a platform 601 which is hosted on a computer which further supports a top voters module 604 where subscribers or audience needs to confirm their name to stay in the entry list for selection as winner, a daily update module 606 where similarly the audience has to login to stay in the list for pick as winner, a top voter display module 607 that displays a list of active audience who vote, and a voter display module 608 that display a priority list of audience users that vote the most.

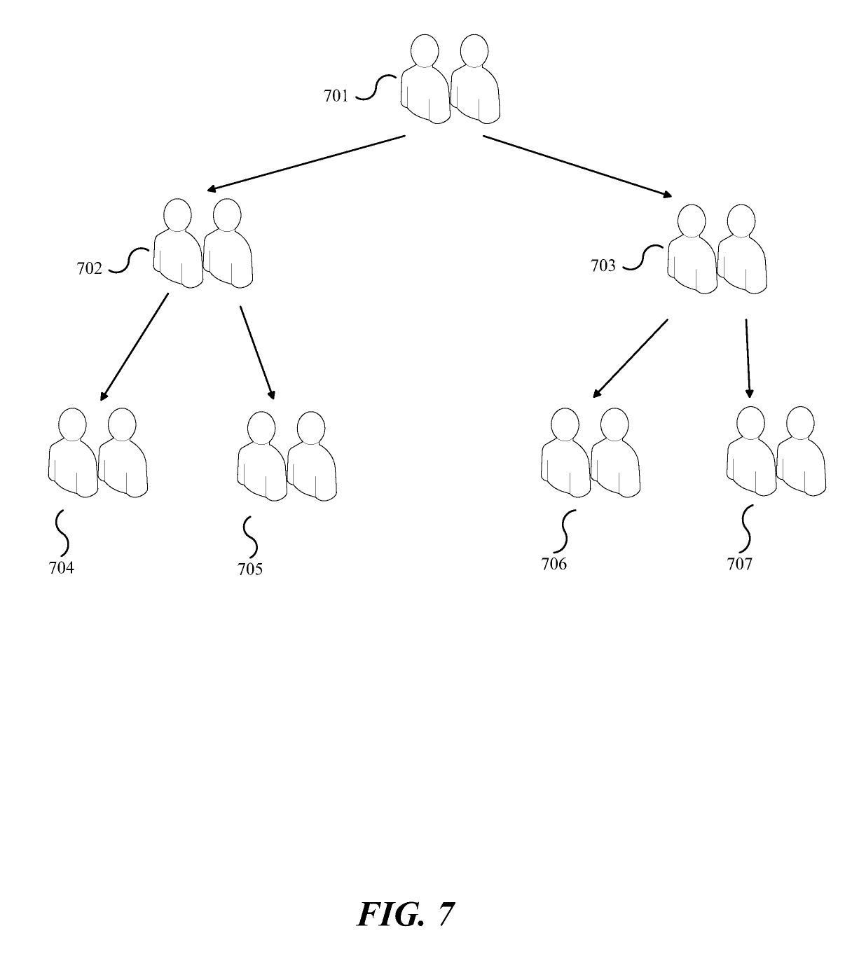

Referring FIG. 7, the schematic flow chart shows the types of judges who will be on the game show to critic or approve the inventor's ideas. Specifically, the judges 701 will be categorized into retail judges 702 and manufacturing judges 703. Retail judges 702 will be either retailing industry experts 704 or mass retailer representatives 705 who may be there to obtain the rights to sell the product at their retail stores. The manufacturing judges 703 are either manufacturing industry experts 706 or manufacturer representatives 707 who may be there to obtain the contract to manufacture the actual product at their manufacturing facility.

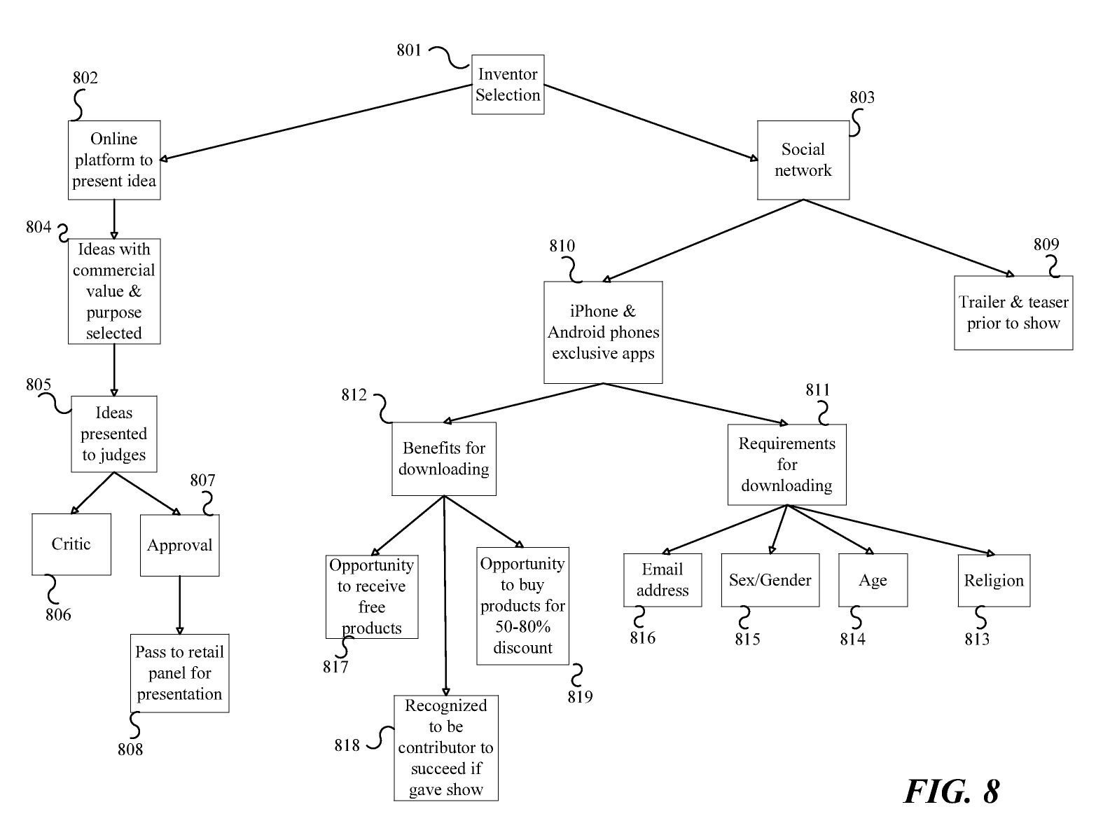

Referring to FIG. 8, the schematic flow chart shows the selection of the inventor and his ideas for the game show. The inventor selection 801 can be categorized into an online platform module 802 and a social network module 803 to present the idea. With the online platform 802, the ideas with commercial value and purposed are selected 804. These ideas are then presented to the judges 805, which may include retail judges and manufacturing judges. The judges will either critique 806 the idea for the product or approve 807 the idea for the product. Once approved 807, the idea for the product will be passed on to the retail panel for presentation 808.

Still referring to FIG. 8, social network 803 will be accomplished through the use of iPhone and Android phone exclusive applications 810 and trailer and teasers 809 prior to the show. The phone applications 810 will provide audiences benefits for downloading 812 and will obtain some information from the audiences 811. The benefits for downloading 812 includes the opportunity to receive free products 817, to be recognized as a contributor to success of the game show and the product 818, and the opportunity to purchase the product at a deep discount 819. The requirements for downloading and participating 811 through the phone application 810 are to provide the audience's religion 813, age or age group 814, sex or gender 815, and email address 816.

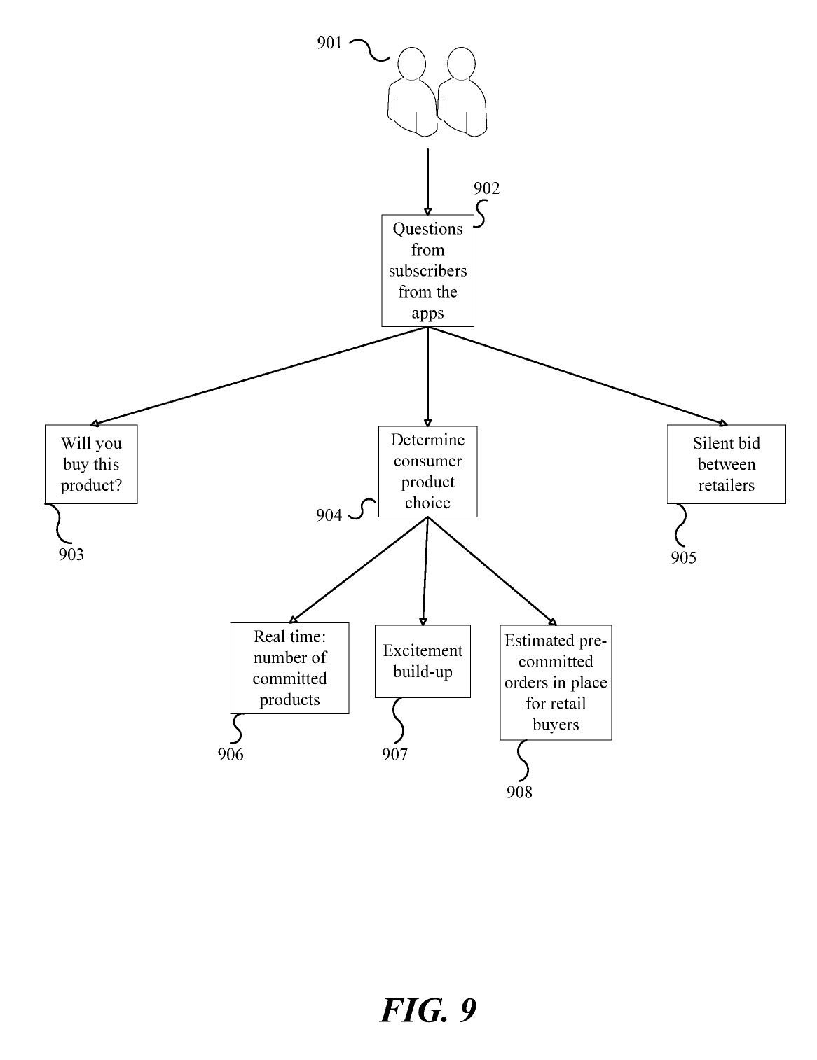

Referring to FIG. 9, the schematic flow chart shows the retail buyer in determining the merits of the inventor's ideas. Specifically, the retail buyer 901 would evaluate the questions from subscribers from the phone application 902. These questions may include whether the subscriber would buy the particular product in question 903. The retail buyer 901 also need to compete with other retailers in a silent bid 905 for the right to sell the product. The retail buyer 901 also needs to determine the consumer product choice 904, which includes the number of committed products 906 in real time, the build up for the excitement of the product 907, and the estimated pre-committed orders in place for the retail buyers 908. In one embodiment, the retail buyer module is hosted by the system on a computer wherein the module provides buyers to review questions from subscribers, consumer product choices which shows the number of committed products.

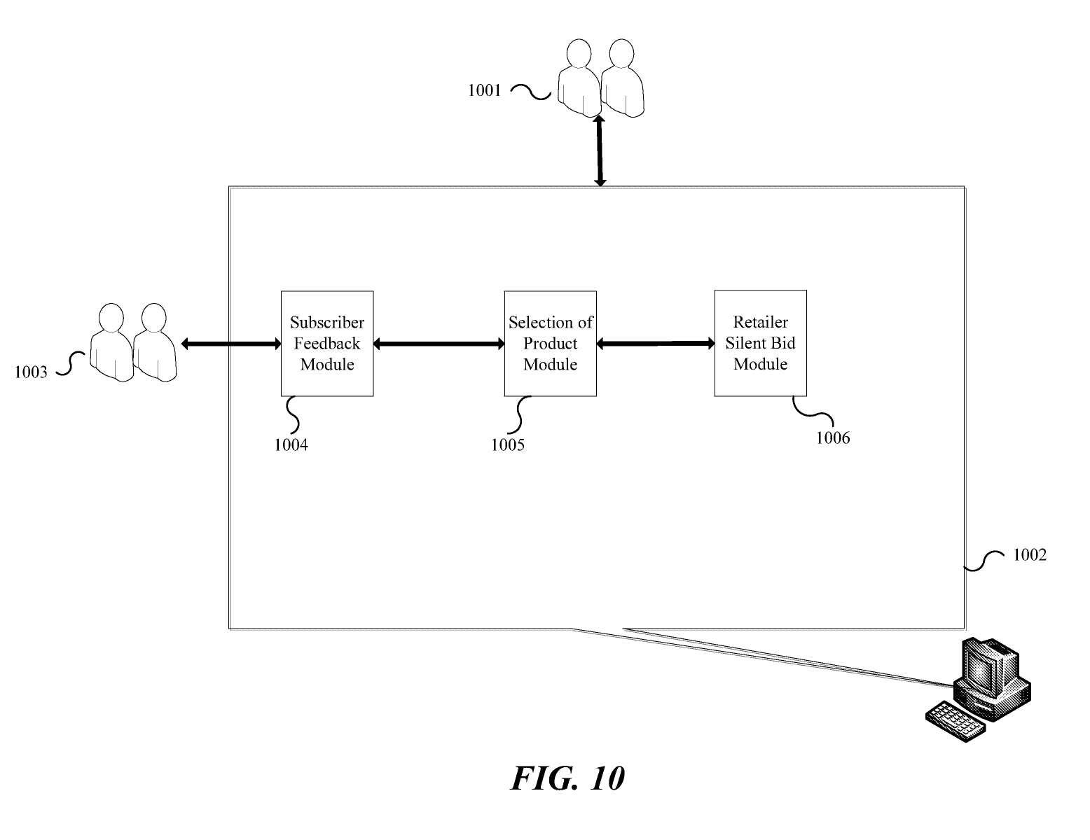

Referring to FIG. 10, the schematic diagram of the system supports retailer buyer module hosted on a platform 1002 which is hosted on a computer which allows the buyer 1001 to interact, and which further supports a subscriber feedback module 1004, a product selection module 1005, and a retailer silent bid module 1006. The subscriber feedback module 1004 allows the subscribers 1003 to provide feedback. Here the module allows for retail buyer to bid for the exclusive right to sell in its chain stores or distribution channel.

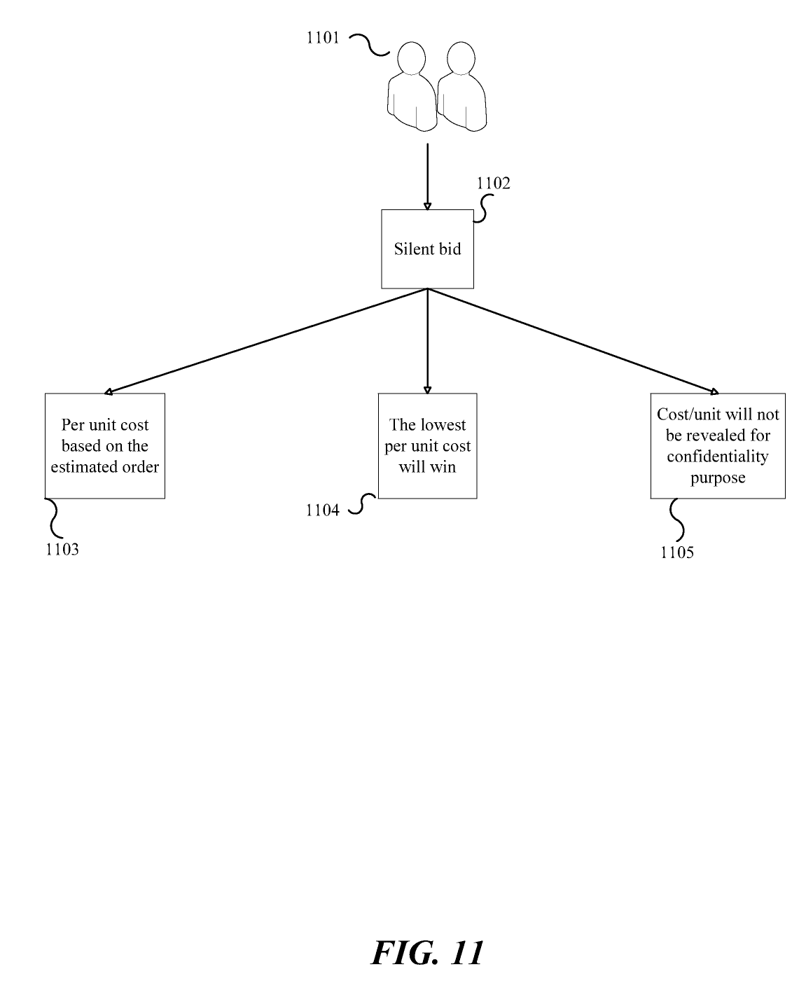

Referring to FIG. 11, the schematic flow chart shows the selection of a manufacturer for the actual production of the inventor's product. Specifically, the manufacturer 1101 will need to compete with one another in a silent bid 1102 to win the contract to manufacture the final product. The manufacturer would need to considered the per unit cost based on the estimated order 1103, the lowest per unit cost will win the bidding 1104, and the cost per unit will not be revealed for confidentiality purposes 1105. In one embodiment, the system further hosts a manufacturing selection module which allows manufacturer competes one another in silent bid to win contract to manufacture the final product.

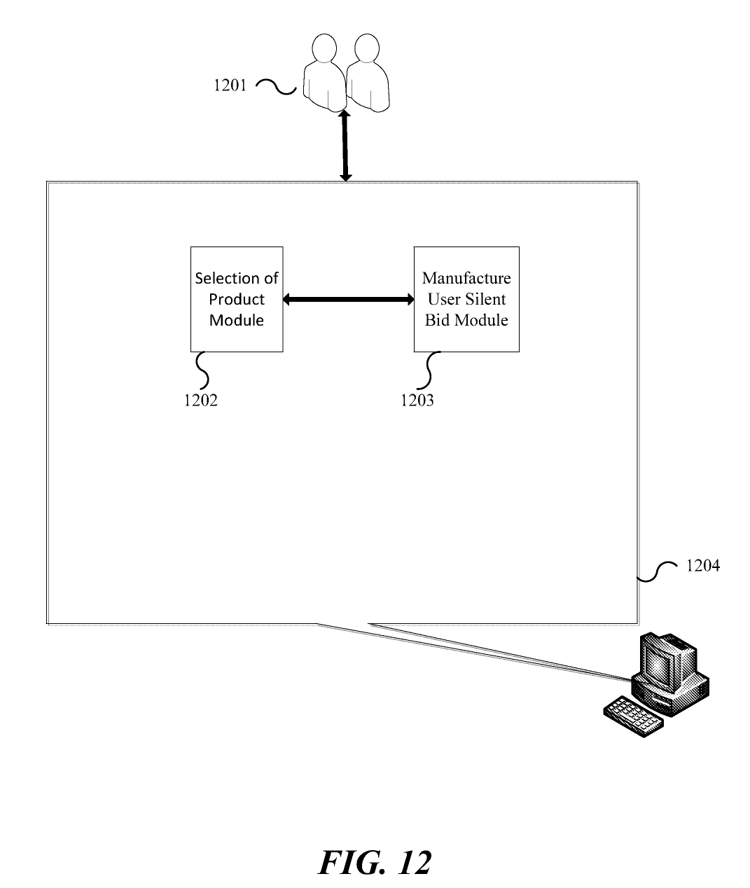

The system of FIG. 12 supports the manufacturing bidding module hosted on a platform 1204 which is hosted on a computer which further hosts the selection of product module 1202 and the manufacturer user silent bid module 1203, allowing the user to interact 1201. Here the manufacture bidding module allows a manufacturer to bid for the right to make the product invention exclusively.

What is claimed is:

1. A system for market validation of product comprising
a. at least one inventor user;
b. at least one retail judge user;
c. at least one manufacturing judge user;
d. at least one audience user;
e. a market validation platform hosted by a computer wherein said market validation platform is comprised of:
i. an inventor selection module wherein said module allows said inventor user to submit said inventor user's product invention;
ii. a retail judge module wherein said retail judge module allows said retail judge user to rate said inventor user's product invention thereby generating a retail judge rating;
iii. a manufacturing judge module wherein said manufacturing judge module allows said manufacturing judge to rate said inventor user's product invention thereby generating a manufacturing judge rating;
iv. an audience user module wherein said audience user module enables said audience user to rate said invention user's product invention thereby generating a audience user rating;
v. a final product module wherein said final product module selects a winning invention based on results of said manufacturing judge module, said retail judge module and raid audience user module.

2. The system of claim 1 wherein the operation of said system is broadcast to public via a television broadcast system.

3. The system of claim 1 wherein said audience user can interact with said inventor user and further interact with said inventor selection module.

4. The system of claim 1 wherein said audience user can interact with said retail judge user and further interact with said retail judge module.

5. The system of claim 1 wherein said audience user can interact with said retail judge module and influence said retail judge rating.

6. The system of claim 1 wherein said audience user can interact with said manufacturing judge and interact with said manufacturing judge module.

7. The system of claim 1 wherein said audience user can interact with said manufacturing judge module and influence said manufacturing judge rating.

8. The system of claim 1 wherein said audience user can interact with said final product module and influence said selection of wining selection.

9. The system of claim 1 further comprising at least one manufacturing user and a manufacturing bidding module wherein said manufacturing user can bid for the right to product said winning selection.

10. The system of claim 1 further comprising at least one retail user and a retail bidding module wherein said retail user can bid for the right to sell said winning selection.

11. The system of claim 10 wherein said retail bidding module further comprises a subscriber feedback module wherein said subscriber feedback module allows said audience user to provide feedback.

12. The system of claim 10 wherein said retail bidding module further comprises a selection module wherein said selection module allow said retail user to review real time committed interests of said winning invention and pre-committed order of said winning invention.

13. The market validation platform of claim 1 further comprising a forum module wherein said forum module is comprised of an inventor page module and a product review module.

14. The system of claim 13 wherein said inventor page module hosts an inventor page for said inventor.

15. The system of claim 13 wherein said product review module is comprised of a judge testimonial module wherein said judge testimonial module hosts testimonials of said retail judge and said manufacturing judge.

16. The system of claim 1 wherein said market validation platform further comprising a incentive module wherein said incentive module comprises a top voter module wherein said top wherein said top voter module hosts an entry of list of said audience user and further provides for said audience user to confirm said entry.

17. The system of claim 1 wherein said market validation platform further comprising a incentive module wherein said incentive module comprises a daily update module wherein said daily update module provides for said audience user to login daily to determine if said audience user is a prize winner.

18. The system of claim 1 wherein said market validation platform further comprising an incentive module wherein said incentive module comprises a priority voter display module wherein said priority voter display module hosts a preferred list of entry of said audience.

19. The system of claim 1 wherein said market validation platform further comprising an incentive module wherein said incentive module comprises a top voter display module wherein said priority voter display module hosts a list of entry of said audience user.

20. The system of claim 1 wherein said audience user module allows said audience user to purchase said winning invention.
